(19) United States
(12) Patent Application Publication
(10) Pub. No.: US 2014/0092418 A1
(43) Pub. Date: Apr. 3, 2014

(54) IMAGE FORMING DEVICE, MANAGEMENT DEVICE, INFORMATION PROCESSING SYSTEM, AND STORAGE MEDIUM

(71) Applicant: CANON KABUSHIKI KAISHA, Tokyo (JP)

(72) Inventor: NORIHISA KISHIMOTO, Kawasaki-shi (JP)

(73) Assignee: CANON KABUSHIKI KAISHA, Tokyo (JP)

(21) Appl. No.: 14/025,086

(22) Filed: Sep. 12, 2013

(30) Foreign Application Priority Data
Oct. 3, 2012 (JP) 2012-220945

(51) Int. Cl. H04N 1/00

(52) U.S. Cl. CPC H04N 1/00896
USPC 358/1.14; 358/1.15

(57) ABSTRACT

An image forming device including an information processing device and an NIC is provided. Upon receipt of a shift to a sleep state, the information processing device disconnects each WebSocket connection established with the server device by a plurality of applications in operation in the information processing device, and the NIC establishes a WebSocket connection with the server device. Also, upon receipt of an establishment request for a WebSocket connection of an application from the server device, the NIC instructs the information processing device to establish the WebSocket connection corresponding to the application.

### BACKGROUND OF THE INVENTION

1. Field of the Invention

The present invention relates to an image forming device, a management device, an information processing system, and a storage medium.

2. Description of the Related Art

There has been proposed a system in which an image forming device inside a LAN (Local Area Network) communicates with an external device that is placed on the Internet outside a firewall. In this system, since communication between the LAN and the Internet is restricted by the firewall, communication from the external device on the Internet to the image forming device inside the LAN cannot be initiated.

Recently, however, there has been proposed a network protocol that allows the external device on the Internet to initiate communication with the image forming device inside the LAN such as a WebSocket disclosed in “RFC6455 The WebSocket Protocol”, http://tools.ietf.org/html/rfc6455. With the aid of this network protocol, connection from the external device on the Internet to the image forming device inside the LAN is established and maintained. By using the established connection by the external device, communication from the Internet side to the LAN side can be realized.

As an example of a system that applies a network connection using the network protocol, a system is assumed in which printing in the image forming device inside the LAN is performed from a mobile terminal that resides on the Internet. A system is also assumed in which devices inside the LAN share information such as an address book saved in the server that resides on the Internet, and which notifies all the image forming devices about a change when the address book is changed.

In communication using the WebSocket, such communication is generally performed in a communication configuration in which a connection is managed, such as a TCP, and a plurality of packets are exchanged to maintain the connection. “TCP” is an abbreviation for “Transmission Control Protocol”. Due to an increase in power-saving needs, there are devices such as an image forming apparatus having installed a power-saving mode function that causes a CPU to sleep in order to suppress power consumption. Further, there are devices that have a WakeOnLAN function among the devices in which the power-saving mode is installed. The WakeOnLAN function is a function that reactivates a main CPU from a sleep state among a plurality of CPUs held by the device when the main CPU is in the sleep state and another CPU has received specific packets. “CPU” is an abbreviation for “Central Processing Unit”.

When a device having the WakeOnLAN function maintains a WebSocket connection, there may be a case where the device reactivates from the power-saving mode to a normal power mode after shifting to the power-saving mode because of maintenance of the connection. Here Japanese Patent Laid-Open No. 2010-283696 discloses a control method for handing over information about an already established connection from a CPU to another CPU and continuing communication by the another CPU.

There are, however, devices on the transmission and reception side that need to retain much information for maintaining certainty of a communication due to the complexity of the communication such as TCP. Therefore, it is difficult for devices to hand over such information between CPUs after the connection is established, or to continue processing in which the connection is kept in the CPU to which the information is handed over. Hence, even if the control method disclosed in the aforementioned Japanese Patent Laid-Open No. 2010-283696 is applied to the image forming device, the power-saving function cannot be enhanced while the image forming device maintains the WebSocket connection (network connection) with the external device.

### SUMMARY OF THE INVENTION

The image forming device of the present invention can enhance a power-saving function even during operation of a network protocol that maintains network connections established with the external device.

The image forming device of an aspect of the present invention includes a processing control unit configured to perform control relating to image processing and a communication control unit configured to control communication with the external device and transfer data from the external device to the processing control unit. Upon detection of a shift to a sleep state, the processing control unit disconnects each first network connection established between the image forming device and the external device for maintaining the network connection through a network protocol and established by a plurality of applications in operation in the processing control unit with the external device, and the communication control unit establishes a second network connection with the external device through the network protocol. Upon receipt of an establishment request, from the external device, for the first network connection between any of the applications and the external device, the communication control unit further instructs the processing control unit to establish the first network connection corresponding to the application that the establishment request indicates.

Further features of the present invention will become apparent from the following description of exemplary embodiments with reference to the attached drawings.

### BRIEF DESCRIPTION OF THE DRAWINGS

FIG. 1 illustrates a system configuration example of the present embodiment.

FIG. 2 illustrates a hardware configuration example of the image forming device.

FIG. 3 illustrates a hardware configuration example of a computer that realizes a firewall, a server device, a client terminal.

FIG. 4 is a block diagram illustrating a software configuration example of an information processing device.

FIG. 5 is a block diagram illustrating a software configuration example of an NIC.

FIG. 6 is a block diagram illustrating a software configuration example of a server device.

FIG. 7 is a block diagram illustrating a software configuration example of a client terminal.

FIG. 8 illustrates an example of a power state table.

FIG. 9A to FIG. 9D illustrate message examples relating to a WebSocket.

FIG. 10A to FIG. 10C illustrate message examples relating to a WebSocket.

FIG. 11 is a sequence diagram illustrating a basic operational processing example of a system in the present embodiment.

FIG. 12 is a sequence diagram illustrating an operational processing example of an overall system when an information processing device shifts to a power-saving mode.

FIG. 13 is a sequence diagram illustrating an operational processing example of an information processing device when the information processing device shifts to a power-saving mode.

FIG. 14 is a sequence diagram illustrating an operational processing example of an NIC when an information processing device shifts to a power-saving mode.

FIG. 15 is a sequence diagram illustrating an operational processing example of a server device when an information processing device shifts to a power-saving mode.

FIG. 16 is a sequence diagram illustrating an operational processing example of an overall system when an information processing device reactivates from a power-saving mode.

FIG. 17 is a sequence diagram illustrating an operational processing example of an NIC when an information processing device reactivates from a power-saving mode.

FIG. 18 is a sequence diagram illustrating an operational processing example of an NIC when an information processing device reactivates from a power-saving mode.

FIG. 19 is a sequence diagram illustrating an operational processing example of an information processing device when the information processing device reactivates from a power-saving mode.

FIG. 20 is a sequence diagram illustrating an operational processing example of an information processing device when an information processing device reactivates from a power-saving mode.

FIG. 21 is a sequence diagram illustrating other operational processing example when an information processing device reactivates from a power-saving mode.

FIG. 22A to FIG. 22C are flowcharts illustrating operational processing by each device in other embodiments.

### DESCRIPTION OF THE EMBODIMENTS

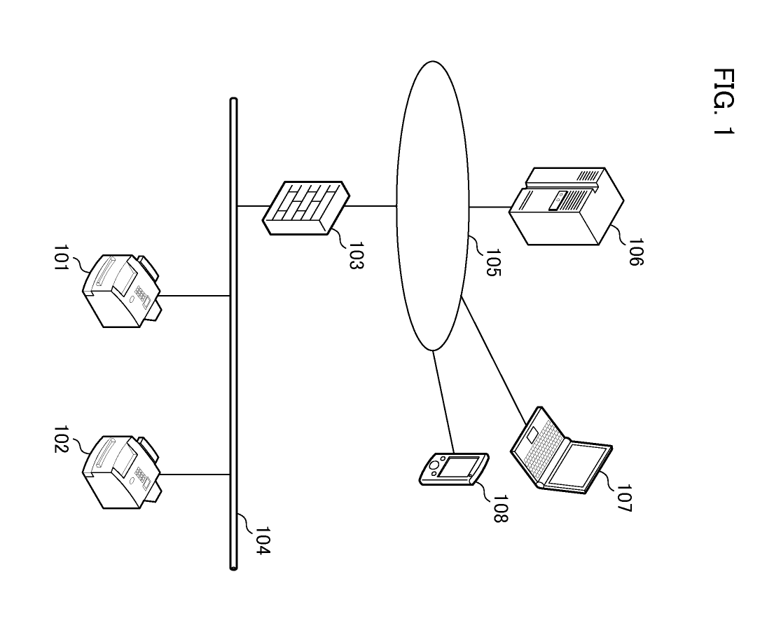

FIG. 1 illustrates a system configuration example of the present embodiment. An information processing system shown in FIG. 1 includes image forming devices 101, 102, and a server device 106.

The image forming devices 101, 102 are connected to a LAN 104. The server device 106 and client terminals 107 and 108 are connected on Internet 105, which is a network example. The image forming devices 101 and 102 and the server device 106 communicate with each other via the Internet 105 and the LAN 104. In the following discussion, the image forming devices 101 and 102 are specifically denoted by “image forming device 101”. Also, the client terminal 107 and 108 are specifically denoted by “client terminal 107”.

The server device 106 provides applications to the client terminal 107 using a Web service and the like. The server device 106 also manages a power state of the image forming device 101. The LAN 104 is insulated from the Internet 105 via the firewall 103, and thus, network communications that are transmitted and received between the LAN 104 and the Internet 105 are restricted. That is, the server device 106 and the client terminal 107 are external devices placed outside the firewall.

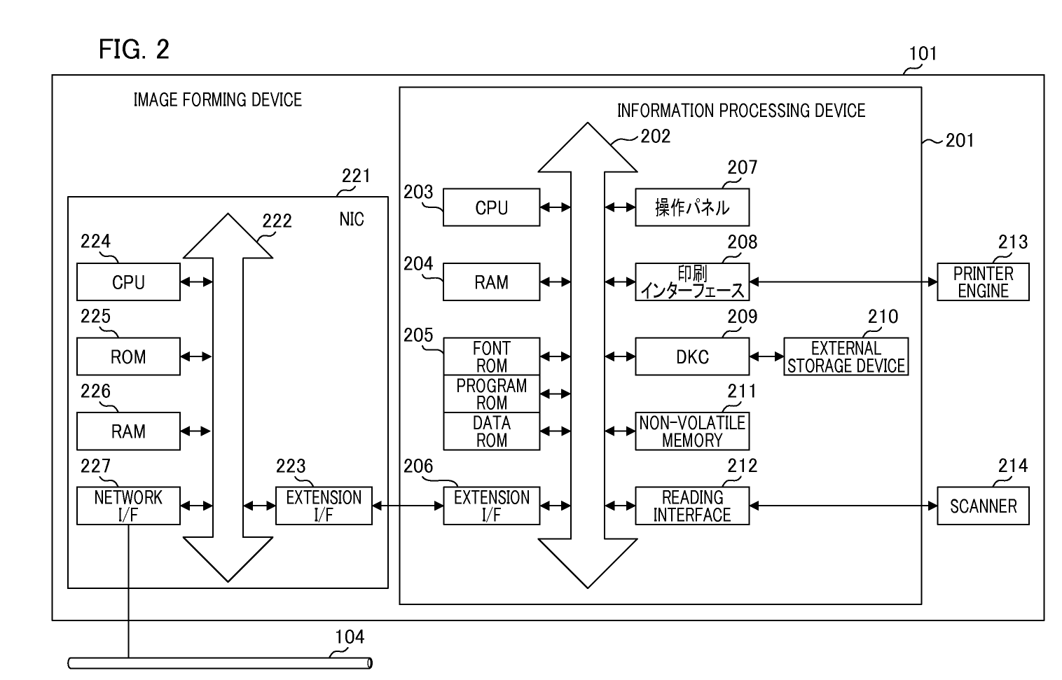

FIG. 2 illustrates a hardware configuration example of the image forming device. The image forming device 101 includes an information processing device 201 and an NIC 221. “NIC” is an abbreviation for “Network Interface Card”.

First, a description will be given of the information processing device 201. The information processing device 201 functions as a processing control unit that performs control relating to image processing. The information processing device 201 includes a CPU 203, a RAM 204, a ROM 205, an extension I/F 206, an operational panel 207, a print interface 208, a DKC 209, an external storage device 210, a non-volatile memory 211, and a reading interface 212. The CPU 203 controls accesses between various devices that are connected to a system bus 202 based on programs stored in a program ROM of the ROM 205 or the external storage device 210. “ROM” is an abbreviation for “Read Only Memory”.

The CPU 203 also outputs image signals to a print unit (a printer engine) 213 that is connected via the print interface 208 as output information The CPU 203 also controls image signals input from a reading unit (a scanner) 214 that is connected via the reading interface 212.

A control program that the CPU 203 can execute is preinstalled in the program ROM of the ROM 205. Font data (including outline font data) that is used when the CPU 203 generates the aforementioned output information is preinstalled in a font ROM of the ROM 205. Information that is used on the client terminal 107 and the like is preinstalled in a data ROM of the ROM 205. The NIC 221 is connected to the CPU 203 via an extension I/F (Interface) 206 so that the CPU 203 realizes communication processing between computers on the network and image forming devices.

The RAM 204 is mainly configured to function as a main memory, a work area or the like for the CPU 203, and to enable memory capacity expansion by means of an option RAM that is connected to an additional port (not shown). Note that the RAM 204 is used for an output information expansion area, an environment data storage area, and the like. “RAM” is an abbreviation for “Random Access Memory”. The access to an external storage device 210, such as a hard disk drive (HDD), an IC card, and the like is controlled by the disk controller (DKC) 209. The external storage device 210 is not limited to one but at least one or more external storage device may be provided, and may be configured to enable multiple connections of external memories that store option font cards in addition to the embedded font, programs that interpret printer control languages different from each other depending on languages.

The hard disk is used for a job storage area for storing an application program, font data, form data and the like, temporary spooling a print job, and controlling the spooled job from outside. The hard disk also holds image data read out from the scanner 214, or image data of a print job as BOX data. In this manner, the hard disk is also used as a BOX data storage area that allows the client terminal 107 on the network to refer image data, or to provide instructions for printing. In the present embodiment, assume that the HDD is used as an external storage device, and holds various logs such as a job log, an image log.

The operation panel 207 accepts various types of information according to a user operation via a software key. The non-volatile memory 211 stores various types of setting information set according to an operation on the operation panel 207. Although not shown in figures, the image forming device 101 can optionally attach various additional devices such as a finisher having a staple or sort function, or duplex device for realizing a duplex printing function. The CPU 203 controls the various additional devices.

Next, a description will be given of an NIC 221. The NIC 221 functions as a communication control unit that controls communications between the server device 106 and the external device such as the client terminals 107 and 108, and transfers data from the external device to the information processing device 201. The NIC 221 includes an extension I/F 223, a CPU 224, ROM 225, a RAM 226, and a network I/F 227. The CPU 224 executes a software program of the NIC 221 to thereby control the device overall. The RAM 226 is a random access memory of the NIC 221, and is used for temporary data storage when the CPU 224 controls the device. The ROM 225 is a read only memory of the NIC 221, and stores a boot program and fixed parameters. The extension I/F 223 is connected to the extension I/F 206 on the information processing device 201 side, and controls data communication between the information processing device 201 and the NIC 221. The network I/F 227 is connected to the network so as to control data communication between the NIC 221 (the information processing device 201 and the image forming device 101) and the external device on the network.

The information processing device 201 shown in FIG. 2 can operate in a normal power mode and a power-saving mode with lower power consumption than the normal power mode by switching the modes. When the normal power mode is shifted to the power-saving mode, a power supply to the CPU 203, the external storage device 210, the non-volatile memory 211 or the like is stopped. In contrast, the NIC 221 operates on an ACIC (Application Specific Integrated Circuit) that differs from the information processing device 201. Thus, even if the information processing device 201 shifts to the power-saving mode, power is continuously supplied to the NIC 221 to thereby enable the image forming device to transmit and receive data flowing on the network. In this manner, even when the information processing device 201 shifts to the power-saving mode, the NIC 221 receives specific data from the network so that the WakeOnLAN function can be realized.

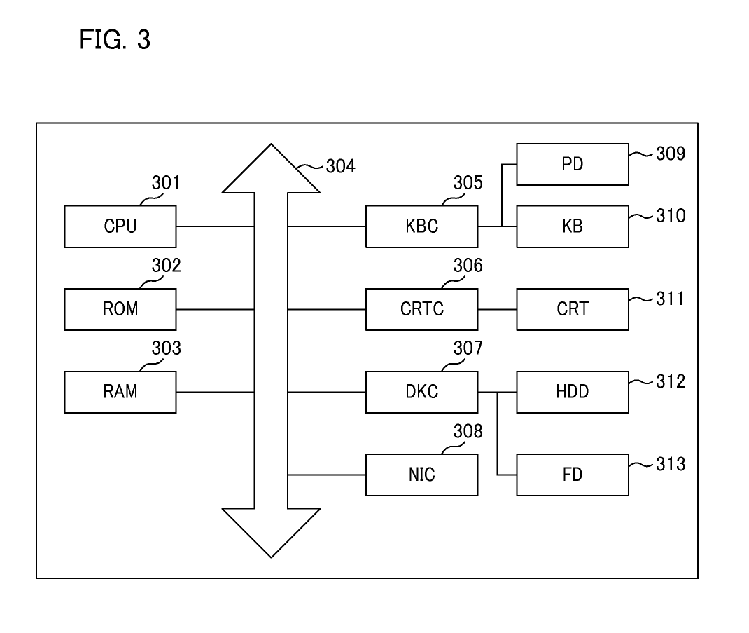

FIG. 3 is a diagram illustrating a hardware configuration example that realizes the firewall, the server device, and the client terminal. The computer shown in FIG. 3 includes a CPU 301, a ROM 302, a RAM 303, a KBC 305, a CRTC 306, a DKC 307, an NIC 308, a PD 309, a KB 310, a CRT 311, an HDD 312, and an FD 313.

The CPU 301 controls various devices connected to a system bus 304. A BIOS or a boot program is preinstalled in the ROM 302. The RAM 303 is used as a main storage device for the CPU 301. The keyboard controller (KBC) 305 performs processing relating to input of information via the pointing device 309 such as a mouse (registered trademark) or the like, or the keyboard 310.

The display control unit (CRTC) 306 internally has a video memory, renders image data in the video memory according to an instruction by the CPU 301 as well as outputting the image data rendered in the video memory as a video signal to a display device (the CRT 311). “CRTC” is an abbreviation for “Cathode Ray Tube Controller”. Although the CRT is exemplified as the display unit in FIG. 3, types of the display device may be any device such as a liquid-crystal display device. The disk controller (DKC) 307 accesses the hard disk drive (HDD) 312, and the floppy (registered trademark), disk 313. The network interface card (a NIC) 308 connects to the network so as to perform information communication. Note that an OS (Operating System) and various application programs that operate on the OS and the like are stored in the HDD 312. In the aforementioned configuration, when the power source of the computer is turned on, the CPU 301 loads the OS from the HDD 312 into the RAM 303 in accordance with the boot program stored in the ROM 302, and functions as an information processing device.

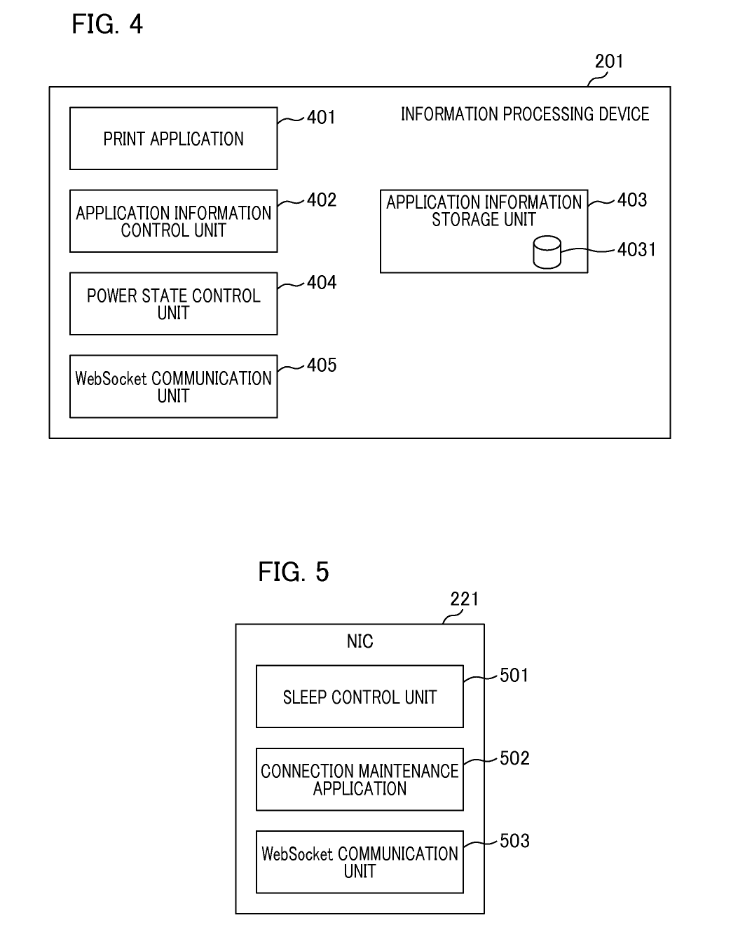

FIG. 4 is a block diagram illustrating a software configuration example of the information processing device provided in the image forming device. The information processing device 201 includes a print application 401, an application information control unit 402, an application information storage unit 403, a power state control unit 404, a WebSocket communication unit 405. In this example, it is assumed that the print application 401 is installed as an application utilizing the WebSocket, but other applications may be installed.

The application information control unit 402 functions as a management unit that manages information relating to applications (application information) that are installed on the information processing device 201. The application information includes an application name, a URL, a port number, a communication state, and the like. The application information is saved in an application management table 4031 held by the application information storage unit 403.

The power control unit 404 monitors a power state of the device so as to control a connection established with the server device 106 when a mode shifts to the power-saving mode or reactivates from the power-saving mode. Specifically, upon shifting to the power-saving mode, the power control unit 404 disconnects a connection through the WebSocket established between the information processing device 201 and the server device 106, and hands over necessary information to the NIC 221. The power control unit 404 also establishes the connection through the WebSocket again upon reactivation from the power-saving mode.

The connection through the WebSocket is a network connection using the WebSocket, and hereinafter denoted “WebSocket connection”. The WebSocket is one of communication standards for interactive communication, and a network protocol having a framework for continuous connection. The WebSocket is also one of basic specifications for HTML5 established by W3C. W3C is abbreviation for “World Wide Web Consorutium”. HTML5 is abbreviation for “HyperText Markup Language 5”. Specifically, the WebSocket continuously maintains a network connection once established between the server (the server device 106) and the client (the image forming device 101). Also, in the state where the network connection is maintained, the WebSocket transmits data from the external device to the internal device in accordance with an event occurrence in the external device. In this manner, the WebSocket can transmit, to the image forming device via the firewall, a request issued with the external device that is disposed outside the firewall as origin. In the communication using the WebSocket, packets for maintaining a connection are transmitted and received between the server and the client, so that the connection is maintained. Therefore, the WebSocket connection applied in the present embodiment is a network connection in which a connection between the server device 106 and the image forming device 101 is maintained until the connection is explicitly disconnected once such connection is established.

When the power control unit 404 detects a shift to the sleep state by the information processing device 201, the power control unit 404 executes the following processing. The power control unit 404 disconnects each WebSocket connection (a first network connection) of which a plurality of applications whose operation is in progress in the information processing device 201, and which is established with the server device 106.

The WebSocket communication unit 405 actually transmits and receives packets of the WebSocket. When exchanging packets, the WebSocket communication unit 405 searches for information of the server device 106 via the application information control unit 402. The WebSocket communication unit 405 examines the association of the retrieved information of the server device 106 and the application information. In this manner, the WebSocket communication unit 405 judges which application is just trying to transmit packets, or of which address to an application the WebSocket communication unit 405 has received packets, thereby appropriately performing transmission and reception processing.

FIG. 5 is a block diagram illustrating a software configuration example of the NIC embedded in the image forming device. The NIC 221 includes a sleep control unit 501, a connection maintenance application 502, and a WebSocket communication unit 503.

The sleep control unit 501 monitors a shift to the power-saving mode, or a reactivation from the power-saving mode by the information processing device 201. The connection maintenance application 502 is an application that ensures a minimal communication with the server device 106 by using the WebSocket even whilst the information processing device 201 is in the power-saving mode. Specifically, when a shift to the sleep state by the information processing device 201 has been detected and the WebSocket connection between operating applications in the information processing device 201 and the server device 106 has been disconnected, the connection maintenance application 502 executes the following processing. The connection maintenance application 502 establishes a WebSocket connection (a second network connection) with the server device 106. The WebSocket communication unit 503 performs a WebSocket communication so that the connection maintenance application 502 and the server device 106 communicate with each other. A control method for controlling the image forming device in the present embodiment is realized by means of functions of each processing unit provided in the information processing device 201 and the NIC 211 described with reference to FIG. 4 and FIG. 5.

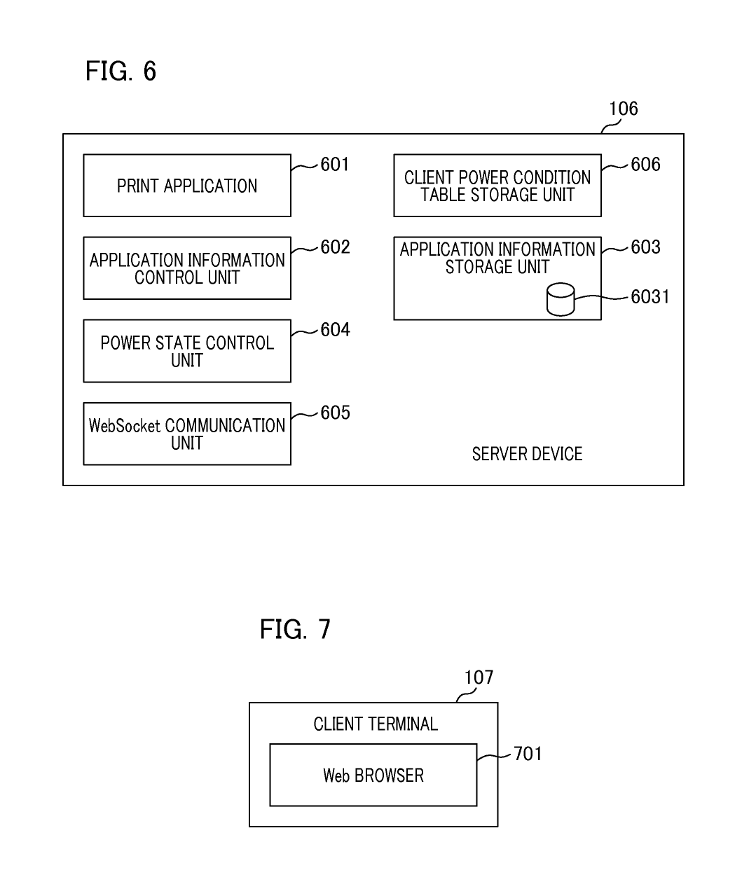

FIG. 6 is a block diagram illustrating a software configuration example of the server device. Upon receipt of a print request from the client terminals 107 or 108 or the like, a print application 601 transfers the received information to the image forming device 101. A WebSocket communication unit 605 intermediates between the print application 601 and the image forming device 101, and performs a WebSocket communication. An application information control unit 602 manages an application that performs communication using the WebSocket.

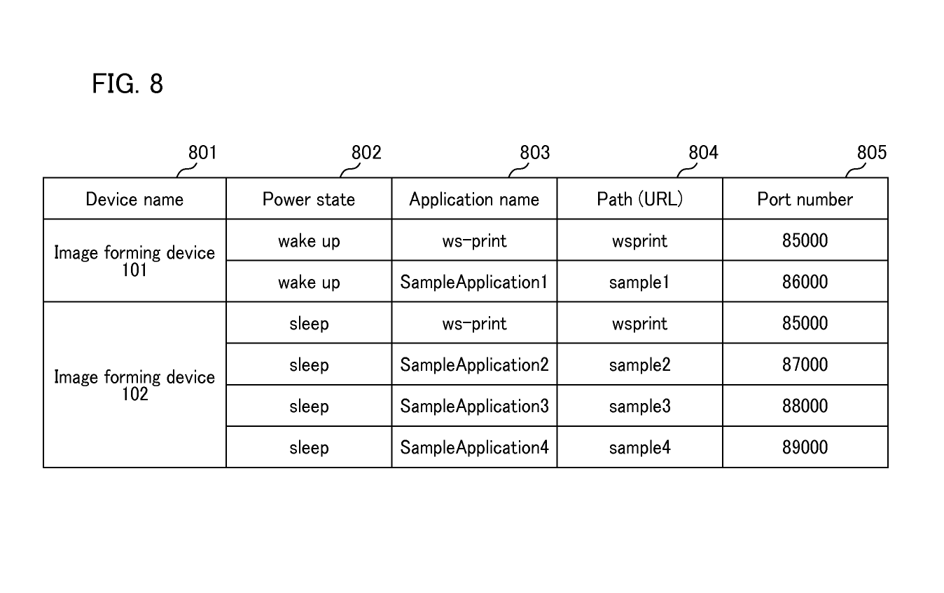

The application information control unit 602 saves application information such as port numbers, URLs, application names, and the like that are used by each application in an application management table 6031 included in an application information storage unit 603. The application information control unit 602 uses the application information for identifying an application when communication has occurred. A power state control unit 604 receives a power state change notification from the image forming device 101, passes the received information to a client power state table storage unit 606, and retains information included in the notification each for each WebSocket of the client. The WebSocket communication unit 605 communicates with the image forming device 101 using the WebSocket. The WebSocket communication unit 605 therefore functions as a connection control unit that establishes a WebSocket connection with operating applications in the information processing device 201 or the NIC211 provided in the image forming device 101. A power state table saving unit 606 retains a power state table having power state information. The power state table is described below with reference to FIG. 8.

FIG. 7 is a block diagram illustrating a software configuration example of the client terminal 107. The client terminal 107 includes a Web browser 701. A terminal client transmits a print request to the server device 106 via the Web browser 701.

FIG. 8 is a diagram illustrating an example of a power state table retained by the client power state table storage unit 606 of the server device. The power state table includes power state information having data items such as a device name 801, a power state 802, an application name 803, a URL 804, a port number 805.

The device name 801 indicates a name of the image forming device. The power state 802 indicates a power state of the image forming device. “Wake up” set in the power state 802 indicates that the image forming device is in a normal state. “Sleep” set in the power state 802 indicates that the image forming device is in a sleep state. In the present embodiment, the sleep state of the image forming device precisely indicates that the information processing device 201 is in the sleep state. The application name 803 indicates a name of an application installed on the image forming device. The URL 804 indicates a URL corresponding to each application. The port number 805 indicates a port number of the server device 106.

In the present embodiment, the application management table 4031 provided in the image forming device 101 and the application management table 6031 provided in the server device 106 have the same configuration as that of the power state table shown in FIG. 8. Thus, in the present embodiment, when application information is referred to in the operational processing by the image forming device 101 or the server device 106, it is assumed that information in the power state table shown in FIG. 8 is used as the application information. Specifically, the power state 802 represented in the power state table also indicates a communication state that indicates whether a WebSocket connection with the server device 106 is maintained or disconnected with respect to a corresponding application. In other words, “wake up” set in the power state 802 indicates that the image forming device is in the normal state as well as indicating that the WebSocket connection is maintained with respect to a corresponding application. Also, “sleep” set in the power state 802 indicates that the image forming device is in the sleep state as well as indicating that the WebSocket connection is in the disconnection state with respect to a corresponding application.

Naturally, the application management tables 4031 and 6031 may have a data configuration different from that of the power state table shown in FIG. 8. For example, instead of the power state 802, the application management tables 4031, 6031 may have a communication state that indicates whether or not the WebSocket connection is established with the server device 106 as a data item.

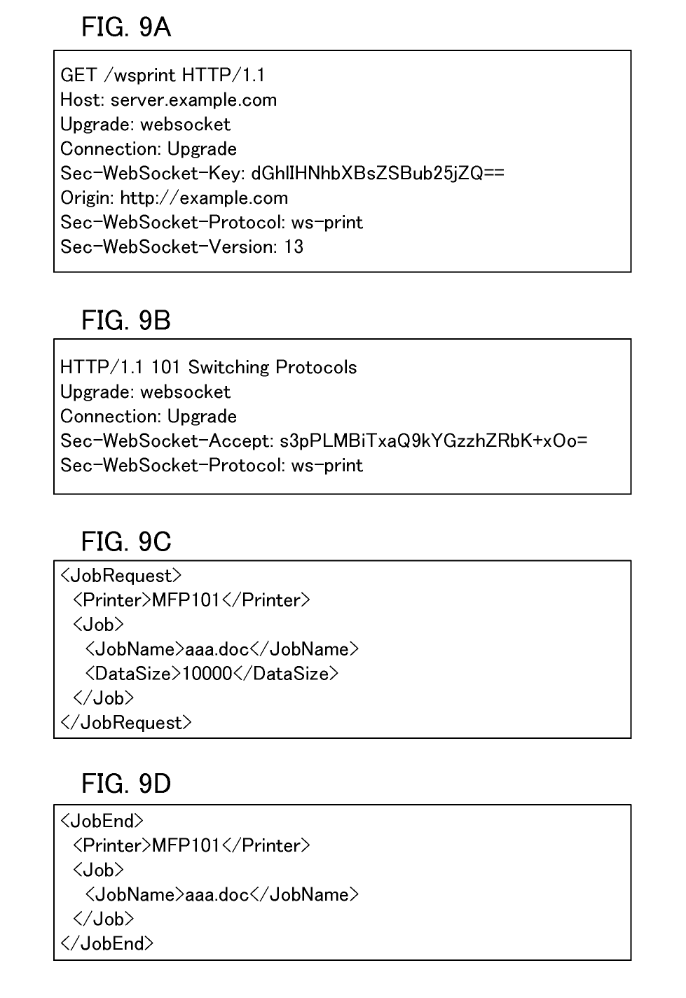

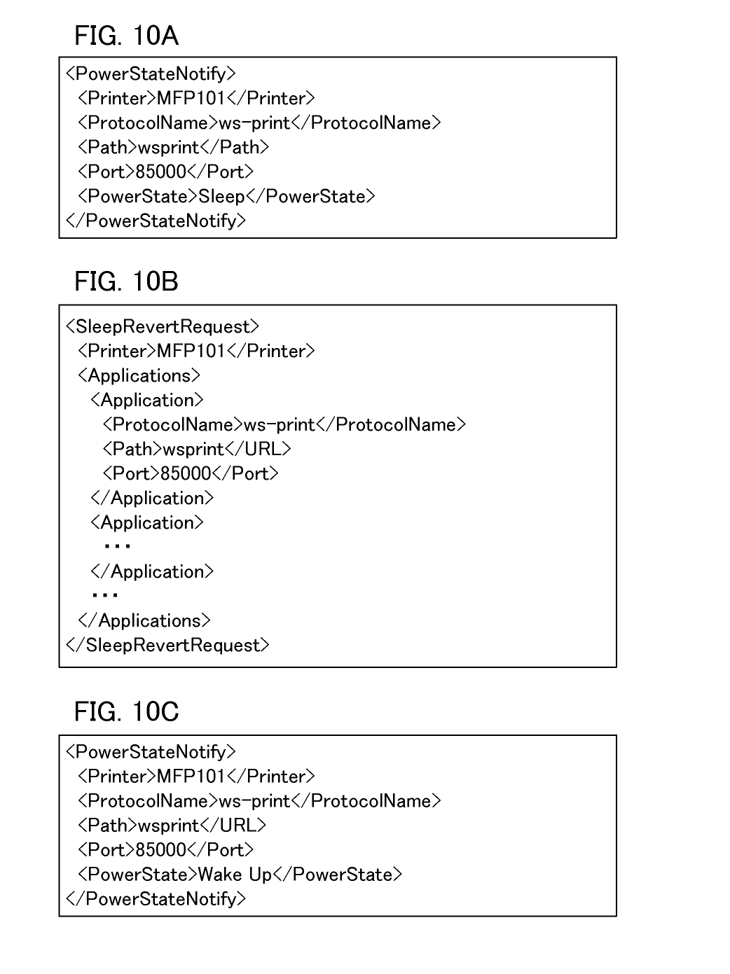

FIG. 9A to FIG. 9D, and FIG. 10A to FIG. 10C are diagrams illustrating message examples relating to the WebSocket which are transmitted and received in the present embodiment. Note that the image forming device 101 and the server device 106 may communicate with each other using messages other than the messages shown in FIG. 9 in the present embodiment.

FIG. 9A is an HTTP message which the image forming device 101 that is a WebSocket client transmits to the server device 106 upon request for a connection. As a value “WebSocket” is set in an “Upgrade” field shown FIG. 9A, the server device 106 discriminates that the WebSocket connection is required. Also, “ws-print” set in “Sec-WebSocket-Protocol” field indicates that this message is requested from the print application 401.

FIG. 9B is a response message which the server device 106 that received the connection request transmits to the image forming device 101 as a result of the message shown in FIG. 9A. In the message example shown in FIG. 9B, a status code is “101 Switching Protocols”. Also, “Sec-WebSocket-Protocol” is “ws-print”. Thus, it is understood that the print application 601 of the server device 106 received the request from the print application 401 of the image forming device 101.

FIG. 9C is a message example which the server device 106 transmit to the image forming device 101. The message shown in FIG. 9C functions as a print request. This message is configured in an XML format. A character string indicating the image forming device 101 that printouts is set in <Printer>. Also, print data is set in <JobName>. In this example, print data having a name “aaa.doc” is set in <JobName>. A print data size is set in <DataSize>. FIG. 9D is a message indicating reception completion of print data transmitted from the image forming device 101 to the server device 106. The contents of the message shown in FIG. 9D are same as those of message shown in FIG. 9C except for the data size.

FIG. 10A is a message by which the image forming device 101 notifies the server device 106 of a shift to the power-saving mode. A character string indicating the printer itself is set in <Printer>. “ws-print”, which indicates a print application, is set in <ProtocolName>. URL information and a port number used by each application are set in <Path> and <Port>, respectively. A subsequent power state is set in <PowerState>. “Sleep” is set in <PowerState> and thus it is understood that the image forming device 101 is going to shift to the power-saving mode.

FIG. 10B is a message transmitted from the server device 106 to the image forming device 101 for prompting a reactivation from the power-saving mode. This message functions as an establishing request, from the server device 106, of the WebSocket connection of an application. In this message, information of the image forming device 101 held by the client power state table holding unit 606 of the server device 106 is set in <Application> and transmitted to the image forming device 101.

FIG. 10C is a message which the image forming device 101 transmits to the server device 106 upon reactivation from the power-saving mode. The contents in this message are same as those of the message shown in FIG. 10A, but “Wake Up” is set in <PowerState> for indicating reactivation completion from the power-saving mode.

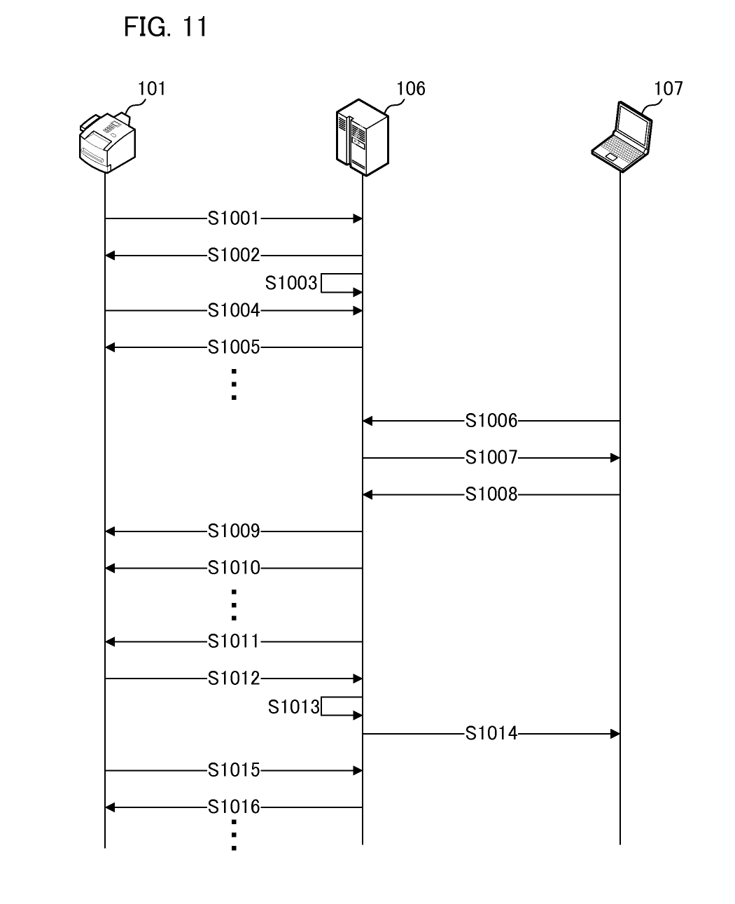

FIG. 11 is a sequence diagraph illustrating a basic operational processing example by the system in the present embodiment. Firstly, the image forming device 101 transmits an HTTP request shown in FIG. 9A to the server device 106 for establishing a WebSocket connection for a print application (S1001). Upon receipt of this HTTP request, the server device 106 replies to the image forming device with an HTTP response shown in FIG. 9B (S1002). At this point, the WebSocket connection for the print application becomes established. At this time, the client power state table storage unit 606 of the server device 106 registers the application information of the established connection in the power state table shown in FIG. 8 (S1003).

Here, it is assumed that an initial value of power state is a normal state (wake up). After this, processing is repeated in which arbitrary packets are periodically transmitted from the image forming device 101 to the server device 106 for maintaining the established WebSocket connection (S1004), and response packets are replied from the server device (S1005). In the present embodiment, although packets are transmitted from the image forming device 101, a configuration may be applied in which packets are transmitted from the server device 106 and the image forming device 101 replies. Also, as arbitrary packets transmitted and received for maintaining the connection, a ping that is generally defined or Keep-Alive that is defined in TCP may be applied.

The client terminal 107 transmits a print request to the server device 106 via the Web browser 701 while the aforementioned packets are transmitted and received (S1006). Subsequently, the server device 106 replies to the client terminal 107 with a response message indicating that the server device 106 can accept the request according to this print request (S1007). The client terminal 107 that has received the response message transmits print data to the server device 106 (S1008). Here, it is assumed that communication between the client terminal 107 and the server device 106 is performed by using a general Web service.

Upon receipt of the print data from the client terminal 107, the server device 106 transmits the print request shown in FIG. 9C to the image forming device 101 through the established WebSocket connection (S1009). The server device 106 then transmits print data to the image forming device 101 (S1010, S1011).

After completing reception of data by size of print data included in the print request, the image forming device 101 transmits a message indicating reception completion (FIG. 9D) to the server device 106 (S1012), and performs print processing (S1013). Subsequently, the server device 106 transmits a print completion message to the client terminal 107 (S1014), and terminates a series of processing. Although there is no detailed description of the print completion message transmitted from the server device 106 to the client terminal 107, the message according to a protocol negotiated between the server device 106 and the client terminal 107 is transmitted.

After the aforementioned print processing, the image forming device 101 and the server device 106 periodically repeat transmission and reception of arbitrary packets again for maintaining the WebSocket connection (S1015, S1016).

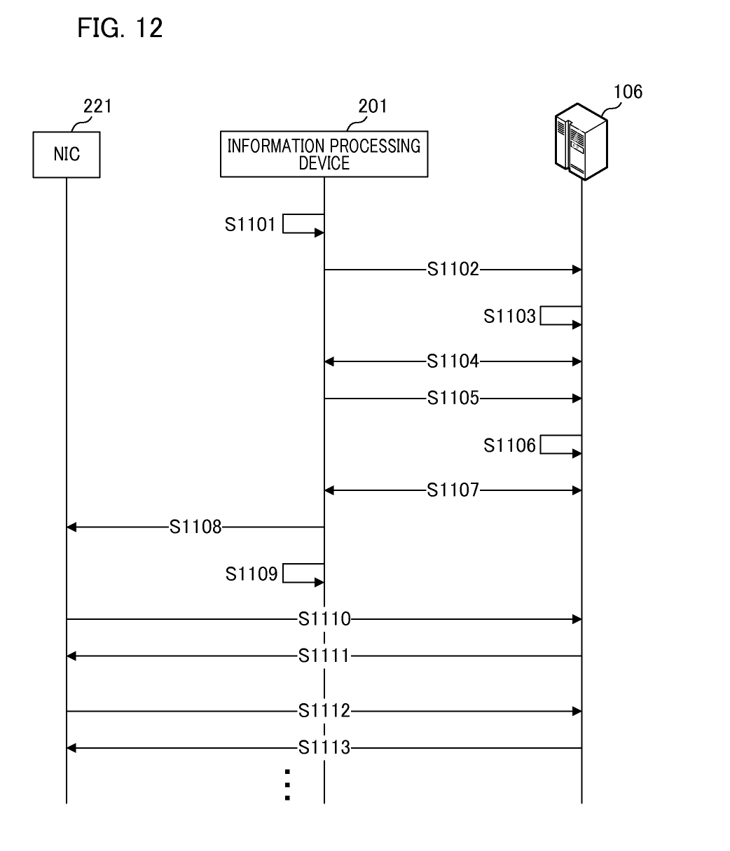

FIG. 12 is a sequence diagram illustrating an operational processing example of overall the system when the information processing device shifts to the power-saving mode. Hereinafter, the information processing device 201 and the NIC 221 of the image forming device 101 are separately described in the sequence diagram since they independently operate. As shown in FIG. 8, WebSocket connections for two applications of the ws-print (print application) and SampleAplication1 has have been already established between the image forming device 101 and the server device 106.

Firstly, the information processing device 201 detects that own mode shifts to the power-saving mode (S1101). The information processing device 201 transmits a message shown in FIG. 10A to the server device 106 through the already established WebSocket connection. In this example, the information processing device 201 firstly transmits the message in FIG. 10A through the connection for the ws-print indicating the print application (S1102). The server device 106 that has received this message changes the power state of the ws-print of a relevant device in the table shown in FIG. 8 to “sleep” (S1103). Then, the information processing device 201 disconnects the connection for the ws-print (S1104).

Next, the information processing device 201 transmits a message that is the same as that shown in FIG. 10A through the connection for the SampleAplication1 (S1105). The server device 106 that has received this message changes the power state of SampleAplication1 of a relevant device in the table shown in FIG. 8 to “sleep” (S1106). Then, the information processing device 201 disconnects the connection for the SampleAplication1 (S1107).

Note that the server device 106 determines that the image forming device 101 has shifted to the power-saving mode when power states of all applications in the image forming device 101 have been changed to “sleep” with reference to the table shown in FIG. 8. After that, the information processing device 201 notifies the NIC 221 of information (server information) relating to the server device 106 (S1108), and shifts to the power-saving mode (S1109). Note that timing when the information processing device 201 shifts to the power-saving mode is generally determined based on, for example, a time information set on a user interface (UI) of the image forming device 101, or a timeout occurrence based on time information from activation. Naturally, the information processing device 201 may shift to the power-saving mode due to an event occurrence other than the timeout serving as a trigger.

The NIC 221 requests the server device 106 for establishment of a WebSocket connection for the NIC 221 based on the server information that NIC 221 was notified about in S1109 (S1110). The server device 106 accepts the establishment request for the WebSocket connection (S1111), and establishes the WebSocket connection. Here, although the NIC 221 and the server device 106 establish only one connection regardless the number of applications held by the information processing device 201, a plurality of connections may be established. The NIC 221 and the server device 106 periodically transmit and receive optional packets for maintaining the established connection (S1112, S1113).

According to the operational processing described with reference to FIG. 11, the image forming device 101 comes into the sleep state after disconnecting WebSocket connections of operating applications, and the NIC 221 separately established the WebSocket connection with the server device 106. Therefore, according to the aforementioned operational processing, the power-saving can be enhanced even during operation of a protocol in which packets for maintaining a connection such as WebSocket are continuously transmitted and received in the image forming device 101. In other words, according to the image forming device of the present invention, the image forming device can come into the sleep state even during operation of the network protocol in which a network connection established between the external device is maintained, and as a result, the power-saving is enhanced.

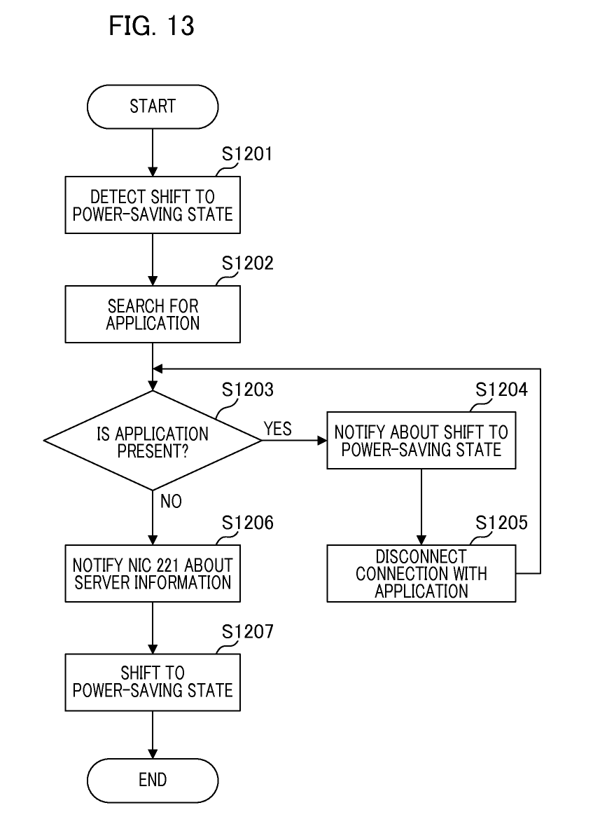

Next, a description will be given of detailed processing described with reference to FIG. 12 and performed by each device upon shift to the power-saving mode with reference to flowcharts shown in FIG. 13 to FIG. 15.

FIG. 13 is a flowchart illustrating an operational processing example of the information processing device when the information processing device shifts its mode to the power-saving mode. The power state control unit 404 of the information processing device 201 detects a shift to the power-saving mode (S1201). Next, the application information control unit 402 searches for an application for which the WebSocket connection is maintained with reference to, for example, application information included in the table shown FIG. 8 (S1202). The application information control unit 402 notifies the power state control unit 404 of a detection result.

Next, the power state control unit 404 determines based on the detection result in S1202 whether or not an application in which the WebSocket connection is maintained is present (S1203). When the application for which the WebSocket connection is maintained is present, the power state control unit 404 decides to disconnect the WebSocket connection corresponding to the relevant application. Then the processing advances to S1204. When the application for which the WebSocket connection is maintained is not present, the processing advances to S1206.

In S1204, the power state control unit 404 executes the following processing through the WebSocket connection of the application for which the WebSocket connection is maintained. The power state control unit 404 notifies the server device 106 that the image forming device 101 has shifted to the power-saving mode by transmitting the message shown in FIG. 10A (S1204).

Then, the power state control unit 404 disconnects the WebSocket connection used upon transmission of the aforementioned message (S1205), the processing reactivates to S1203.

According to the aforementioned description from S1201 to S1205, the power state control unit 404 functions as a notification unit that executes the following processing. The power state control unit 404 searches for an application that is in the WebSocket connection-established state with the server device 106 based on the application information. The power state control unit 404 disconnects this WebSocket connection after notifying the server device 106 that the image forming device has shifted to the sleep state through the WebSocket connection corresponding to the retrieved application.

In S1206, the power state control unit 404 notifies the NIC 221 of information about the server device 106 (S1206). Then, the information processing device 201 shifts to the power-saving mode (S1207).

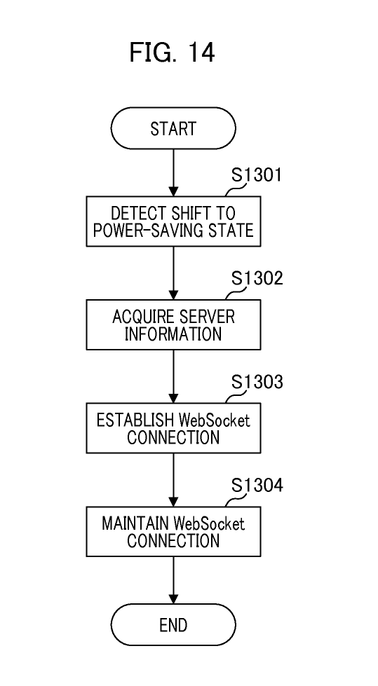

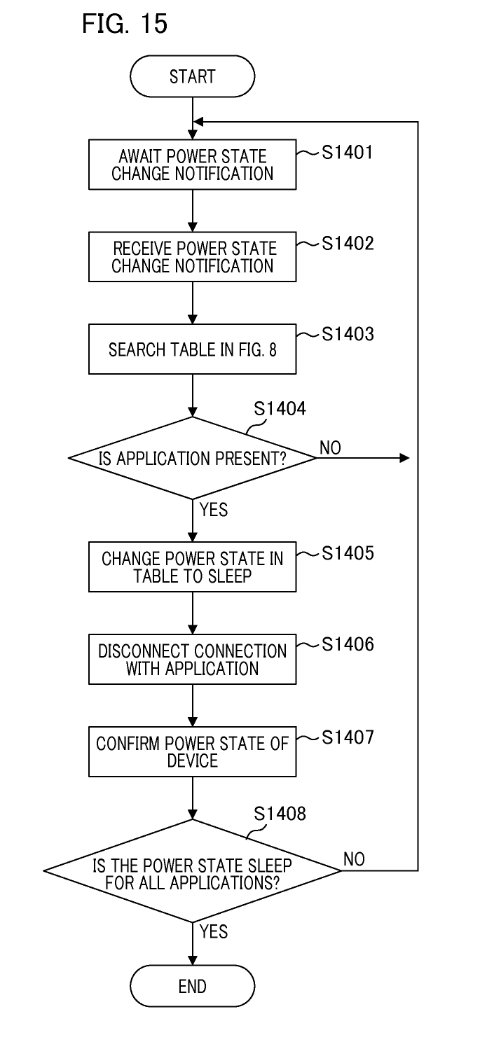

FIG. 14 is a flowchart illustrating an operational processing example of the NIC when the information processing device shifts to the power-saving mode. The sleep control unit 501 of the NIC 221 detects a shift to the power-saving mode by the information processing device 201 (S1301). Next, the sleep control unit 501 acquires the information about the server device 106 for which notification was provided from the power state control unit 404 of the information processing device 201 in S1206 of FIG. 13 (S1302). The sleep control unit 501 passes the acquired information to the connection maintenance application 502 of the NIC 221.

The connection maintenance application 502 exchanges messages shown in FIGS. 9A and 9B with the server device 106 based on the received information about the server device 106 to thereby establish the WebSocket connection (S1303). After that, the connection maintenance application 502 maintains the connection by periodically transmitting and receiving arbitrary packets (S1304).

FIG. 15 is a flowchart illustrating an operational processing example of the server device when the information processing device shifts to the power-saving mode. The power state control unit 604 of the server device 106 awaits a power state change notification (S1401). In this condition, the power state control unit 604 receives the power state change notification shown in FIG. 10A from the information processing device 201 (S1402). Next, the power state control unit 604 searches for an entry of an application that is operating on the image forming device corresponding to the received power state change notification from the table shown in FIG. 8 (S1403) to thereby determine whether or not the operating application is present (S1404).

When the operating application is not present, the processing again returns to S1401, and awaits the power state change notification. When the application is present, the power state control unit 604 changes the item of the power state corresponding to the relevant application in the table shown in FIG. 8 to “sleep” (S1405). Then, the power state control unit 604 disconnects the WebSocket connection corresponding to this application (S1406).

Next, the power state control unit 604 confirms whether or not the power states of all applications have been changed to “sleep” with reference to FIG. 8 (S1407). In this manner, the power state control unit 604 determines whether or not the power states have been changed to “sleep” with respect to all applications (S1408). When the power states have been changed to “sleep” with respect to all applications, the processing is terminated. When the application of which corresponding power state has not been changed to “sleep” is present, the processing returns to S1401.

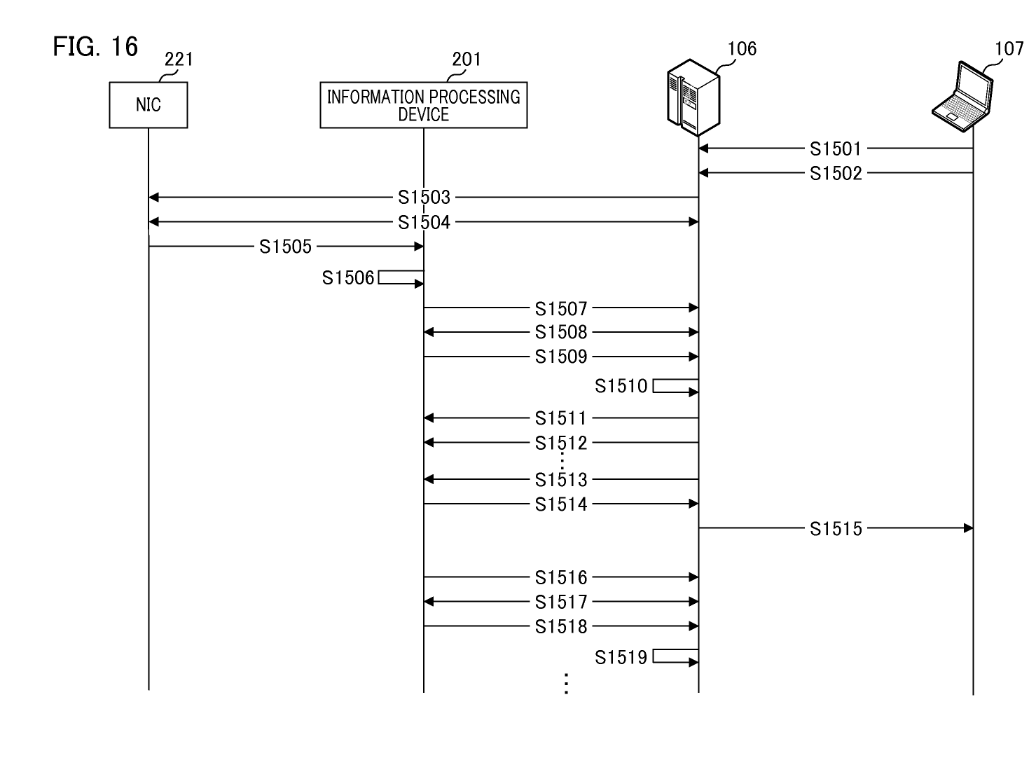

FIG. 16 is a sequence diagram illustrating an operational processing example of the overall system when the information processing device in the power-saving mode wakes up. In the present embodiment, the NIC 221 has a WakeOnLAN function that reactivates the information processing device 201 from the power-saving mode by receiving specific packets via the network. Here, it is assumed that the information processing device 201 has already shifted to the power-saving mode (the sleep state) by means of the method described above.

If printing is instructed by the client terminal 107 when the information processing device 201 is in the power-saving mode, the client terminal 107 transmits a print request to the server device 106 as normal (S1501), and transmits print data (S1502). The server device 106 that has received the print request from the client terminal 107 transmits the message shown in FIG. 10B through the WebSocket connection established with the NIC 221 of the image forming device 101 (S1503). The message shown in FIG. 10B includes information of the image forming device 101 registered with the table shown in FIG. 8.

Next, the server device 106 disconnects the WebSocket connection established between the NIC 221 and the server device 106 (S1504). Then, the NIC 221 passes information included in the received message in FIG. 10B to the information processing device 201 (S1505). The information processing device 201 that has received the information reactivates from the power-saving mode (S1506).

Next, the information processing device 201 re-establishes the WebSocket connection that had been established before shifting to the power-saving mode. The information processing device 201 decides an application corresponding to the WebSocket connection to be re-established based on the information included in the message in FIG. 10B. In this example, the print application is decided as the application corresponding to the WebSocket connection to be re-established. Through transmission and reception of messages shown in FIG. 9A and FIG. 9B between the information processing device 201 and the server device 106, the WebSocket connection for the print application is established (S1507, S1508). Then, the information processing device 201 transmits the message shown in FIG. 10C to the server device 106 through the established connection in order to indicate that this established connection is the connection after reactivating from the power-saving mode (S1509). The server device 106 that has received this message changes the power state of the print application of the image forming device 101 from “sleep” to “wake up” in the table shown in FIG. 8 (S1510).

Next, the server device 106 transmits the print request shown in FIG. 9C to the information processing device 201 for processing the instruction (the print request) in response to a user operation of the client terminal 107 (S1511). In S1511, the server device 106 transmits this print request through the WebSocket connection re-established with the information processing device 201. Next, the server device 106 transmits print data to the information processing device 201 (S1512 to S1513). When the information processing device 201 has completed reception of all print data, the information processing device transmits the message shown in FIG. 9D to the server device 106 (S1514). Then, the server device 106 transmits a response to the client terminal 107 for indicating completion of printing (S1515).

At the same time as the aforementioned processing, the exchange of messages shown in FIGS. 9A and 9B is performed between the information processing device 201 and the server device 106 with respect to SampleAplication1, the WebSocket connection for the SampleAplication1 is established (S1516, S1517). Subsequently, the message shown in FIG. 10C is transmitted from the information processing device 201 to the server device 106 (S1518). The server device 106 that has received this message changes the power state of the SampleAplication1 in the table shown in FIG. 8 from “sleep” to “wake up”. In this manner, the reactivation processing from the power-saving mode is completed.

According to the operational processing described with reference to FIG. 16, the image forming device 101 reactivates from the power-saving mode due to receipt of a service providing request (a print request) from the server device 106 that has received an instruction in response to the user operation of the client terminal 107. Then, the image forming device 101 establishes the WebSoket connection corresponding to the application that provides the aforementioned service. Thus, according to the aforementioned operational processing, the image forming device 101 in the power-saving mode can reactivate interactive communication between the application that realizes the service provision and the server device 106 due to receipt of the service providing request.

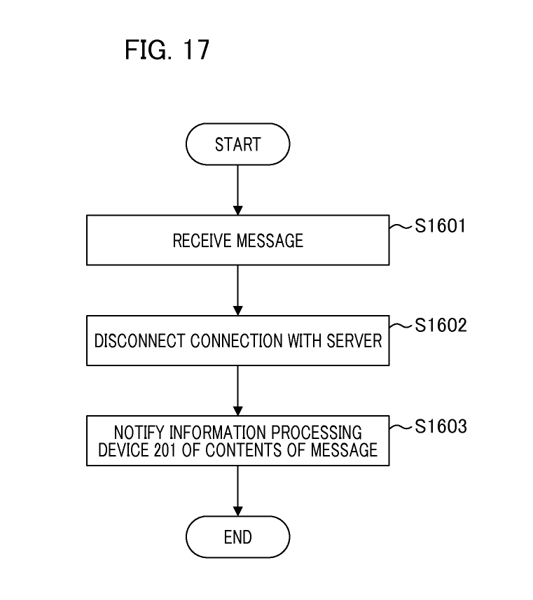

Next, with reference to flowcharts shown in FIG. 17 to FIG. 20, a description will be given of a detail of operational processing of each device when the image forming device 101 reactivates from the power-saving mode and described with reference to the FIG. 16.

FIG. 17 is a flowchart illustrating an operational processing example of the NIC when the information processing device reactivates from the power-saving mode. The WebSocket communication unit 605 of the server device 106 functions as a transmission unit that transmits the message (data) shown in FIG. 10B to the NIC 211. The connection maintenance application 502 of the NIC 221 receives this message from the WebSocket communication unit 605 of the server device 106 (S1601). Next, the connection maintenance application 502 disconnects the WebSocket connection established with the server device 106 through the WebSocket communication unit 503 (S1602). Then, the connection maintaining application 503 passes contents of the message shown in FIG. 10B to the sleep control unit 501, the sleep control unit 501 notifies the information processing device 201 of the contents of the message shown in FIG. 10B (S1603). That is to say, the notification notified in S1603 functions as an instruction, with respect to the information processing device 201, for establishing the WebSocket connection corresponding to the application included in the message shown in FIG. 10B.

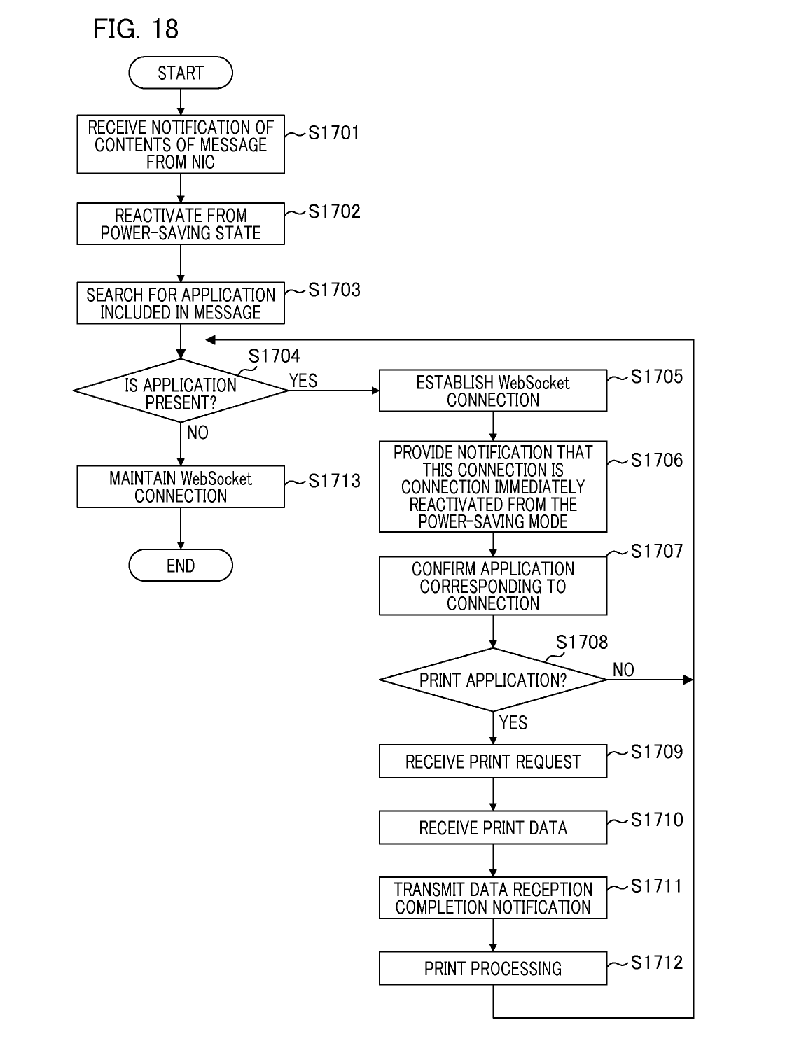

FIG. 18 is a flowchart illustrating an operational processing example of the information processing device when the information processing device reactivates from the power-saving mode. The power state control unit 404 of the information processing device 201 receives the notification of information included in the message shown in FIG. 10 from the NIC 221 (S1701). The power state control unit 404 causes the information processing device 201 to reactivate from the power-saving mode based on this notification (S1702). That is to say, the power state control unit 404 functions as a reactivation unit that causes the image forming device to wake up from the sleep state due to the instruction for establishing the WebSocket connection of the application to the information processing device 201 by the NIC 221.

Next, the power state control unit 404 refers to application information, and searches for the application included in the message shown in FIG. 10B (S1703). The application included in the message shown in FIG. 10B is a processing target, namely the application for which the WebSocket connection should be established. Subsequently, the power state control unit 404 determines whether or not an unprocessed application is present in the application information (S1704).

When the unprocessed application is present in the application information, the power state control unit 404 executes the following processing. The power state control unit 404 establishes the WebSocket connection corresponding to the relevant application with the server device 106 via the WebSocket communication unit 405 (S1705). Specifically, the power state control unit 404 establishes the WebSocket connection corresponding to the operating application on the information processing device 201 according to the instruction from the NIC 221.

After establishing the WebSocket connection, the power state control unit 404 transmits the message shown in FIG. 10C to the server device 106 for providing notification that this connection is the connection immediately reactivated from the power-saving mode (S1706).

Next, the power state control unit 404 confirms the application corresponding to the established WebSocket connection (S1707). In this manner, the power state control unit 404 determines whether or not the established WebSocket connection is the WebSocket connection corresponding to the print application (S1708).

When the established WebSocket connection is not the WebSocket connection corresponding to the print application, the processing reactivates to S1704. When the established WebSocket connection is the WebSocket connection corresponding to the print application, the processing advances to S1709.

In S1709, the print application 401 performs print processing according to the operational processing described with reference to FIG. 11. That is to say, the print application 401 receives the print request and print data (S1709, 1710). After transmitting a reception completion notification of the print data to the server device 106, the print application 401 performs print processing (S1712). Then, the processing reactivates to S1704.

When the determination processing in S1704 indicates NO, or specifically, unprocessed application is not present in application information, the processing advances to S1713. Then the WebSocket communication unit 405 maintains the WebSocket connection of the application (S1713).

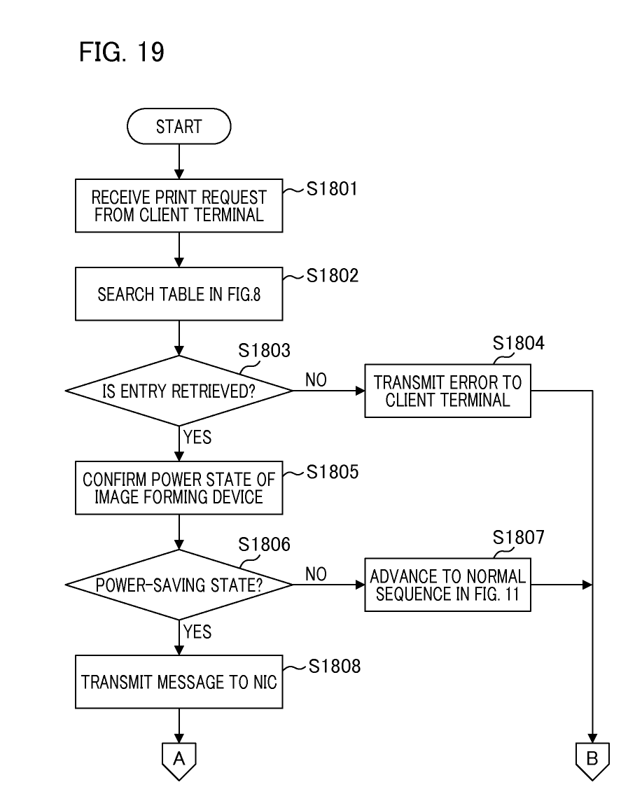

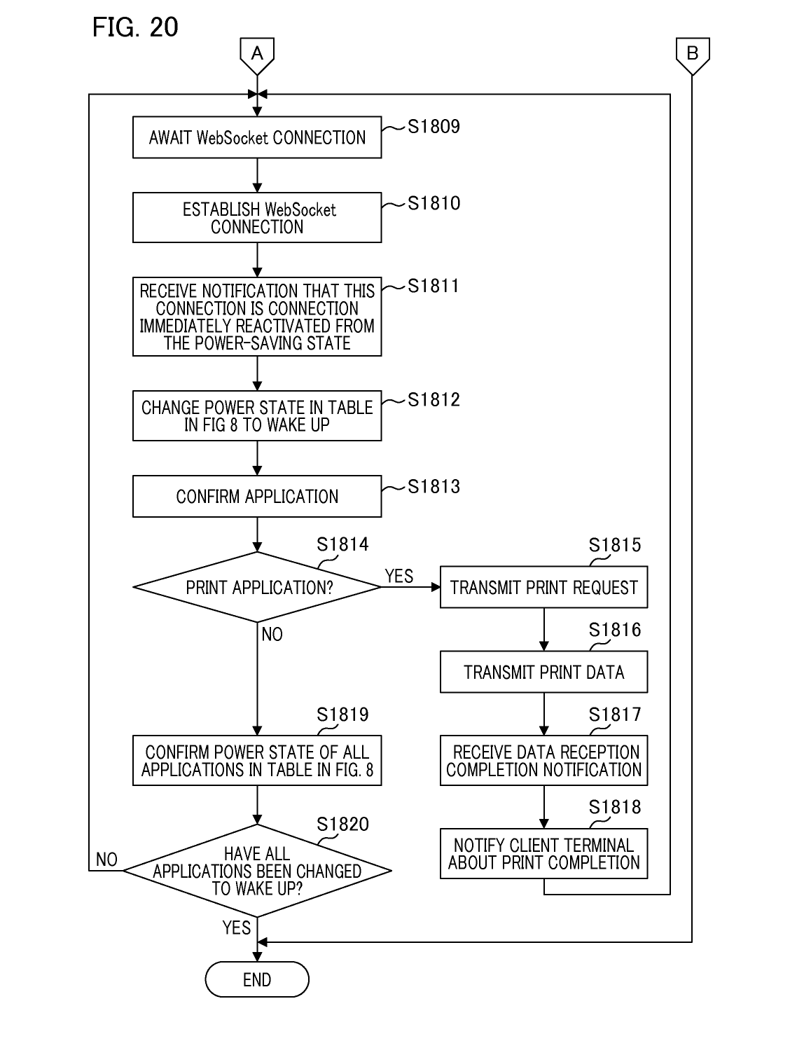

FIG. 19 and FIG. 20 are flowcharts illustrating operational processing of the server device when the information processing device reactivates from the power-saving mode. In S1801 of FIG. 19, the print application 601 of the server device 106 receives a print request and print data from the client terminal 107 (S1801).

Next, the application information control unit 602 searches the table in FIG. 8 held by the client power state table storage unit 606 (S1802). The application information control unit 602 determines based on the search processing in S1802 whether or not an entry of a relevant image forming device and application has been retrieved (S1803). When the entry of the relevant image forming device and application has not been retrieved, the application information control unit 602 transmits an error to the client terminal 107 (S1804), the processing terminates (FIG. 20).

When the entry of the relevant image forming device and application has been retrieved, the power state control unit 604 confirms the power state of the relevant image forming device (S1805). The power state control unit 604 determines based on the confirmation result whether or not the image forming device 101 is in the sleep state (S1806). When the image forming device 101 is not in the sleep state but in the normal state, the operational processing described with reference to FIG. 11 is executed (S1807).

When the image forming device 101 is in the sleep state, the power state control unit 604 transmits the message shown in FIG. 10B to the NIC 221 (S1808), and the processing advances to S1809 of FIG. 20.

Next, in S1809 of FIG. 20, the power state control unit 604 awaits establishment of the WebSocket connection by the image forming device 101 (S1809). Subsequently, the power state control unit 604 establishes the WebSocket connection with the image forming device 101 via the WebSocket communication unit 605 (S1810). Then, the power state control unit 604 receives, from the image forming device 101, the message shown in FIG. 10C that indicates this connection is the connection immediately reactivated from the power-saving mode (S1811).

Next, the power state control unit 604 changes the power state of the relevant application in the table of FIG. 8 held by the client power state table storage unit 606 from “sleep” to “wake up” (S1812). Further, the power state control unit 604 confirms the application (S1813), and determines whether or not the relevant application is the print application 601 (S1814). When the application is the print application 601, the print application 601 performs print processing according to the operational processing described with reference to FIG. 11. That is, the print application 601 transmits the print request and print data (S1815, 1816). After receiving a print data receipt completion notification from the image forming device 101, the print application 601 transmits a print completion notification to the client device 107 (S1818), the processing advances to S1809.

On the other hand, when it is determined that the application is not the print application in the determination processing in S1814, the power state control unit 604 executes the following processing. The power state control unit 604 searches the table in FIG. 8, and confirms the power states of all applications (S1819). Then, the power state control unit 604 determines whether or not the power states of all applications have been changed to “wake up” (S1820).

When the power states of all applications have been changed to “wake up”, the processing terminates. When there is an application of which power state has not been to “wake up”, the processing returns to S1809, and the power state control unit 604 waits for a connection of other application.

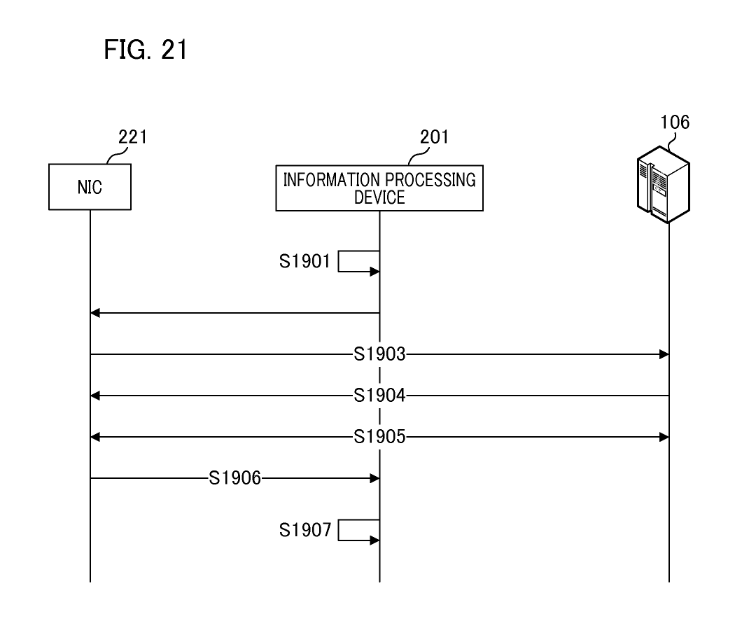

FIG. 21 illustrates another embodiment, and a sequence diagram illustrating another operational processing example when the information processing device reactivates from the power-saving mode. In this operational processing example, the image forming device 101 reactivates from the power-saving mode not via the network but reactivates from the sleep state due to an event occurrence depending on a user operation.

In FIG. 21, difference in processing from the operational processing in the case where the image forming device reactivates from the power-saving mode via the network is processing up to reactivation processing from the power-saving mode by the information processing device 201. Thus, a description of the processing after the information processing device 201 has reactivated is omitted.

When the information processing device 201 detects a reactivation from the power-saving mode (S1901), the NIC 221 (S1902) is notified about the detection result. The NIC 221 transmits the message shown in FIG. 10C to the server device 106 (S1903). The server device 106 transmits the message shown in FIG. 10B to the NIC 221 (S1904).

Next, the NIC 221 disconnects the WebSocket connection established with the server device 106 (S1905). Subsequently, the NIC 221 passes the contents of the message received in S1904 to the information processing device 201 (S1906), and the information processing device 201 completes reactivation from the power-saving mode (S1907). Then, the information processing device 201 establishes the WebSocket connection for each application included in the message received in S1904.

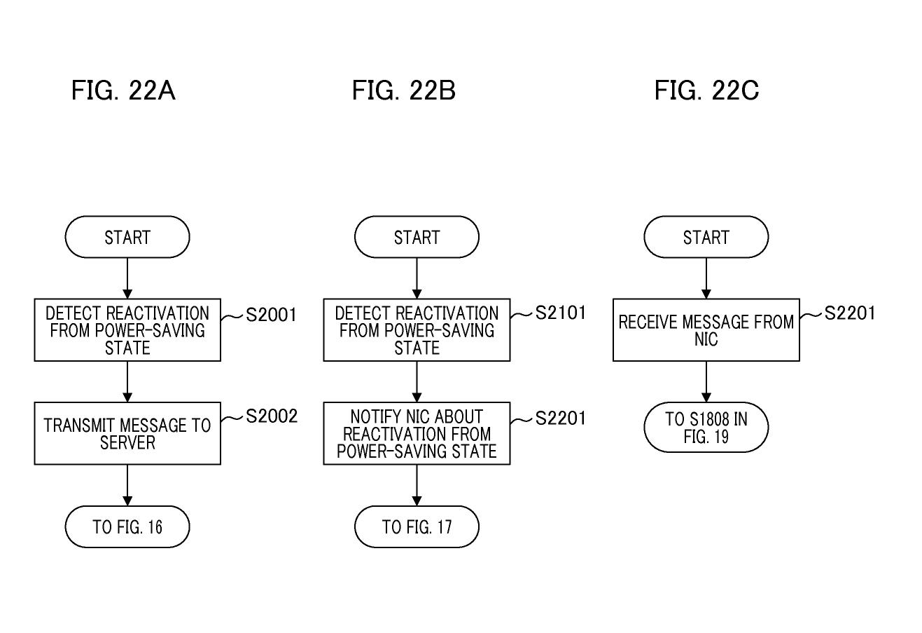

FIGS. 22A, 22B, and 22C are flowcharts illustrating operational processing examples of each device in another embodiment. FIG. 22A illustrates processing of the NIC 221. The processing shown in FIG. 22A differs from the processing shown in FIG. 17 on the following points. The sleep control unit 501 of the NIC 221 receives a reactivation notification from the power-saving mode from the information processing device 201 (S2001). The sleep control unit 501 transmits the message shown in FIG. 10C to the server device 106 via the WebSocket communication unit 503 (S2002). Subsequent processing is the same as that described with reference to FIG. 17.

FIG. 22B illustrates processing of the information processing device. The processing shown in FIG. 22B differs from the processing shown in FIG. 18 on the point that the information processing device 201 itself detects a reactivation from the power-saving mode (S2101). Upon detection of a reactivation from the power-saving mode, the power state control unit 404 notifies the NIC 221 of reactivation from the power-saving mode (S2102). Subsequent processing is same as that described with reference to FIG. 18.

FIG. 22C illustrates the processing of the server device. The processing shown in FIG. 22C differs from the processing shown in FIG. 19 on the point that there is no access from the client terminal 107, and power state control unit of the server device 106 first receives the message shown in FIG. 10C from the NIC 221 (S2201). In this example, the same processing subsequent to S1808 of FIG. 19 is performed due to receipt of the message shown in FIG. 10C.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-220945 filed Oct. 3, 2012, which is hereby incorporated by reference herein in its entirety.

What is claimed is:

1. An image forming device comprising:
a processing control unit configured to perform a control relating to image processing; and
a communication control unit configured to control communication with an external device and transfer data from the external device to the processing control unit,
wherein, upon detection of a shift to a sleep state, the processing control unit disconnects each first network connection established between the image forming device and the external device for maintaining a network connection through a network protocol and established with the external device by a plurality of applications in operation in the processing control unit,
wherein the communication control unit establishes a second network connection with the external device through the network protocol, and
wherein, upon receipt of an establishment request, from the external device, for the first network connection between any of the applications and the external device, the communication control unit further instructs the processing control unit to establish the first network connection corresponding to the application which the establishment request indicates.

2. The image forming device according to claim 1, wherein the processing control unit further comprises a management unit configured to manage application information relating to each application included in the processing control unit, and decides the first network connection based on the application information managed by the management unit when the shift to the sleep state is detected.

3. The image forming device according to claim 1, wherein the processing control unit further comprises a notification unit configured to search for the application that establishes the first network connection with the external device based on the application information managed by the management unit, and disconnect the first network connection through the first network connection corresponding to the retrieved application after providing notification to the external device about the shift to the sleep state.

4. The image forming device according to claim 3, wherein the notification unit notifies the first network connection corresponding to the application in accordance with the communication control unit that provides instructions to establish the first network connection corresponding to the application in operation in the processing control unit.

5. The image forming device according to claim 1, wherein the communication control unit establishes the second network connection with the external device when all the first network connections have been disconnected.

6. The image forming device according to claim 1, wherein the processing control unit further comprises a reactivation unit configured to wake up the processing control unit from the sleep state due to the fact that the communication control unit has instructed the processing control unit to establish the first network connection upon receipt of the establishment request from the external device for the first network connection of the application through the network protocol.

7. The image forming device according to claim 6, wherein the communication control unit receives, through the second network connection, the establishment request for the first network connection of the application through the network protocol from the external device that has accepted a request for service provision provided by using the application.

8. The image forming device according to claim 1, wherein the processing control unit further comprises a reactivation unit that wakes up the processing control unit from the sleep state due to an event occurrence in accordance with a user operation.

9. The image forming device according to claim 1, wherein the network protocol is for allowing the external device that is located outside a firewall to transmit a request issued with the external device as origin to the image forming device via the firewall.

10. The image forming device according to claim 1, wherein the network protocol is a WebSocket.

11. A management device that functions as an external device to communicate with the image forming device according to claim 1, comprising:
a transmission unit configured to transmit data to the communication control unit provided in the image forming device; and
a connection control unit configured to establish the first network connection with any of the applications included in the processing control unit provided in the image forming device and establish the second network connection with the communication control unit provided in the image forming device,
wherein the transmission unit transmits an establishment request, to the communication control unit, for the first network connection between the management device and the application.

12. A system that comprises an image forming device and a management device that communicates with the image forming device,
wherein the image forming device comprises:
a processing control unit configured to perform control relating to image processing; and
a communication control unit configured to control communication with the external device and transfer data from the management device to the processing control unit,
wherein upon detection of a shift to a sleep state, the processing control unit disconnects each first network connection established between the image forming device and the external device for maintaining the network connection through a network protocol and established by a plurality of applications in operation in the processing control unit with the external device,
wherein the communication control unit establishes a second network connection through the network protocol with the management device, and
wherein upon receipt of an establishment request, from the external device, for the first network connection between any of the applications and the external device, the communication control unit further instructs the processing control unit to establish the first network connection corresponding to the application which the establishment request indicates, and
wherein the management device comprises:
a transmission unit configured to transmit data to the communication control unit provided in the image forming device; and
a connection control unit configured to establish the first network connection with the any one of applications included in the processing control unit provided in the image forming device, and establish the second network connection with the communication control unit provided in the image forming device,
wherein the transmission unit transmits an establishment request, to the communication control unit, for the first network connection between the management device and the application.

13. A non-transitory storage medium on which is stored a computer program for making a computer execute a method for controlling an image forming device, comprising:
performing, by a processing control unit provided in the image forming device, control relating to image processing; and
controlling, by a communication control unit provided in the image forming device, communication with the external device and the transfer of data from the external device to the processing control unit,
wherein, upon detection of a shift to a sleep state, the processing control unit disconnects each first network connection established between the image forming device and the external device for maintaining a network connection through a network protocol, and established with the external device by a plurality of applications in operation in the processing control unit,
wherein the communication control unit establishes a second network connection with the external device through the network protocol, and
wherein, upon receipt of an establishment request, from the external device, for the first network connection between any of the applications and the external device, the communication control unit further instructs the processing control unit to establish the first network connection corresponding to the application which the establishment request indicates.
